(19) United States
(12) Patent Application Publication
(10) Pub. No.: US 2009/0052906 A1
(43) Pub. Date: Feb. 26, 2009

(54) Optical Transmission Between a First Unit and a Plurality of Second Units Interconnected by Means of a Passive Optical Access Network

(75) Inventors: Erwan Pincemin, Gommenec'h (FR); Franck Payoux, Lannion (FR)

Correspondence Address: COHEN, PONTANI, LIEBERMAN & PAVANE LLP, 551 FIFTH AVENUE, SUITE 1210, NEW YORK, NY, 10176, US

(73) Assignee: France Telecom, Paris (FR)

(21) Appl. No.: 11/887,813

(22) PCT Filed: Apr. 4, 2006
(86) PCT No.: PCT/FR2006/050293

§ 371 Date: Oct. 3, 2007

(30) Foreign Application Priority Data
Apr. 5, 2005 (FR) 05003344

(51) Int. Cl. H04B 10/04

(52) U.S. Cl. 398/182

(57) ABSTRACT

System and method of transmitting downlink and uplink data traffic between a central office terminal (15) and a plurality of customer terminals (17) Interconnected by means of a passive optical access network (5), comprising the following steps: sending data carried by an amplitude-division multiplexed optical signal (S) including a plurality of amplitudes and having a single wavelength to said plurality of customer terminals (17); converting the single wavelength of said optical signal (S) sent by said central office terminal (15) into a plurality of wavelengths according to said plurality of amplitudes, by spectrum shifting, thereby forming a wavelength-division multiplexed optical signal, so that said data is received by said plurality of customer terminals (17) in a plurality of optical signals (S₁, . . . , S_{N}) at a plurality of different wavelengths, each of said customer terminals (17) receiving the data that is associated with it on at least one specific wavelength; and routing said downlink and uplink traffic between said central office terminal (15) and the customer terminals (17).

### TECHNICAL FIELD OF THE INVENTION

The invention relates to passive optical network (PON) type access networks and more particularly to optical transmission between a first unit and a plurality of second units interconnected by means of a passive optical access network.

### BACKGROUND OF THE INVENTION

At present, the access networks of telecommunication operators mostly make use of wired access, carrying technologies such as ADSL. Optics are not used very much because the infrastructure cost generated by installing optical fibers between central offices and subscribers is prohibitive.

The use of optics in an access network based on PON type architectures enables a significant leap forward in terms of capacity, impossible to achieve by means of wired access technologies, but unavoidable given the rise in the bit rates of services addressed to subscribers.

Generally speaking, PON type access networks are of two types, known as standard PONs and wavelength-division multiplex (WDM) PONs.

Standard PONs use multiple time-division access and require only one transmitter at the transmission central office. They are based on 1×N optical couplers, N being the number of customers or subscribers. In this configuration, the information carried by a signal sent by the transmission central office is sent to all subscribers and dedicated terminals on each subscriber premises then extract the information actually intended for the corresponding subscriber. Thus data conveyed from the transmission central office on a single wavelength is time-division demultiplexed in each customer terminal on the subscriber premises.

However, the customer terminal is complex and the attenuation of the signal by a 1×N coupler is not negligible. Moreover, the fact that information is extracted in each customer terminal raises security issues.

WDM PONs use wavelength-division distribution of resources. In other words, each customer is allocated a specific wavelength. In effect, a wavelength is assigned to each subscriber in the transmission central office. Each specific wavelength is then filtered out by an optical demultiplexer and sent to the corresponding subscriber. This type of network therefore requires the use of a number of wavelength-division multiplexers equal to the number of subscribers and a demultiplexer.

Thus a WDM PON type network has the advantages over a standard PON type network of simplicity, since each wavelength is assigned to a specific subscriber, and of performance, since an optical demultiplexer attenuates much less than a 1×N coupler.

In contrast, it is more costly, because it uses a greater number of wavelengths and a routing element (optical demultiplexer) that is more costly than the simple 1×N coupler.

There is also known a central office including a tunable laser that can be switched to emit at a plurality of different wavelengths. Thus customers are addressed one after the other by tuning the wavelength. However, the tunable laser must operate at a bit rate N times greater than that allocated to customers, and a switching time must be added, which is 50 nanoseconds (ns) in the best-case scenario, which is far from negligible in very high bit rate communication systems.

### OBJECT AND SUMMARY OF THE INVENTION

An object of the invention is to remedy those drawbacks and to simplify optical transmission between a first unit and a plurality of second units.

These objects are achieved by means of a method of optical transmission between a first unit and a plurality of second units, said first and second units being interconnected by means of a passive optical access network, in which method said first unit sends data carried by an optical signal having a single wavelength and received by said plurality of second units in a plurality of optical signals at a plurality of different wavelengths so that each of said second units receives data that is associated with it on at least one specific wavelength.

Thus the plurality of signals can be generated with a single transmitter in the first entity sending a signal having a single wavelength whilst employing wavelength-division distribution of resources by allocating at least one specific wavelength to each second unit. This reduces costs (compared to a standard WDM PON) and enhances performance and security and simplifies the PON type network.

According to one feature of the present invention, the optical signal sent by said first unit is an amplitude-division multiplexed optical signal having a plurality of amplitudes and at least one particular amplitude is assigned to each of said second units.

Thus the amplitude-division multiplexed optical signal provides a simple and instantaneous way to assign each second unit a clearly defined amplitude for the pulses of the signal carrying the data.

The single wavelength of said optical signal sent by said first unit is advantageously converted by a non-linear spectrum shifting effect into a plurality of wavelengths conforming to said plurality of amplitudes, thereby forming a wavelength-division multiplexed optical signal.

By means of the conversion from time-division multiplexing to wavelength-division multiplexing, a spatial distribution of the wavelengths is obtained such that each second unit receives only the wavelength that is associated with it. This enhances data security and simplifies data reception by the second units.

The invention is also directed to a system for optical transmission between a first unit and a plurality of second units, said first and second units being interconnected by means of a passive optical network, in which system said first unit includes a transmitter adapted to send data carried by an optical signal having a single wavelength and said plurality of second units includes a plurality of receivers adapted to receive the data in a plurality of optical signals having a plurality of different wavelengths so that each of said second units is adapted to receive the data that is associated with it on at least one specific wavelength.

Because the first unit includes only one transmitter for sending a signal having a single wavelength, the architecture of the system is very simple to implement. Moreover, the system offers optimum security and good performance because it associates at least one specific wavelength with each second unit.

According to one feature of the present invention, the optical signal sent by the transmitter of said first unit is an amplitude-division multiplexed optical signal having a plurality of amplitudes so that at least one particular amplitude is assigned to each of said second units.

Thus the amplitude-division multiplexing of an optical signal provides a simple and instantaneous correspondence between the various amplitudes and the plurality of second units.

The system advantageously includes non-linear means adapted to convert the single wavelength of said optical signal sent by said first unit into a plurality of wavelengths conforming to said plurality of amplitudes by spectral shifting, thereby forming a wavelength-division multiplexed optical signal.

Thus the non-linear means effect conversion from time-division multiplexing to wavelength-division multiplexing, associating at least one specific wavelength with each second unit. This enhances security and simplifies the architecture of the system.

According to another feature of the present invention, the system includes a demultiplexer disposed downstream of said non-linear means and adapted to demultiplex said wavelength-division multiplexed optical signal into said plurality of optical signals in order to send them to said plurality of second units.

Thus the demultiplexer allocates each second unit a non-attenuated signal having a specific wavelength. A demultiplexer disposed downstream of the non-linear means enables the non-linear means to shift the wavelength proportionately to the power of the data addressed to each second unit.

The system of the invention comprises a central office terminal comprising the first unit and a plurality of customer terminals each comprising one second unit from said plurality of second units.

Thus the central office terminal includes only one transmitter for sending a signal on a single wavelength at the same time as allocating a specific wavelength to each customer terminal.

The invention is also directed to an optical transmission central office terminal including a transmitter adapted to send data carried by an amplitude-division multiplexed optical signal and having a single wavelength and non-linear means adapted to convert said amplitude-division multiplexed optical signal into a wavelength-division multiplexed optical signal by spectrum shifting.

Because a single transmitter for sending an optical signal at a single wavelength and linear means for spatial distribution of the wavelengths are sufficient, the architecture of the equipment is very simple.

In a first embodiment, the central office terminal includes a receive demultiplexer, a plurality of receivers each connected to said receive demultiplexer, and a circulator disposed between the non-linear means and said receive demultiplexer.

Thus the circulator routes appropriately the optical signals sent and received by the central office terminal.

In a second embodiment, the central office terminal includes further non-linear means, a receiver connected to said further non-linear means, and a circulator disposed between said non-linear means and said further non-linear means.

This second embodiment has the advantage of having only one receiver in the central office terminal.

In a third embodiment, the central office terminal includes a receiver and a circulator disposed between the transmitter and the non-linear means and is connected to said receiver.

This third embodiment has the advantage of having only one non-linear means and only one receiver in the central office terminal.

The invention is also directed to an optical transmission customer terminal including a receiver/transmitter adapted to receive or send data carried by an optical signal at a specific wavelength from or to a central office terminal having the above features.

Thus the customer terminal is very secure and very simple because it is not necessary to have any specific means for extracting data that is addressed to it.

### BRIEF DESCRIPTION OF THE DRAWINGS

Other features and advantages of the invention emerge on reading the description given below by way of non-limiting illustration with reference to the accompanying drawings, in which:

FIG. 1 illustrates a highly-diagrammatic example of an optical transmission system according to the invention between a first unit and a plurality of second units interconnected by means of a passive optical network;

FIG. 2 shows one embodiment of the optical transmission system from FIG. 1;

FIG. 3 shows one example of an optical transmission system from FIG. 1 between a central office terminal and a plurality of customer terminals; and

FIGS. 4 to 6 show several embodiments of the central office terminal from FIG. 3.

### DETAILED DESCRIPTION OF EMBODIMENTS

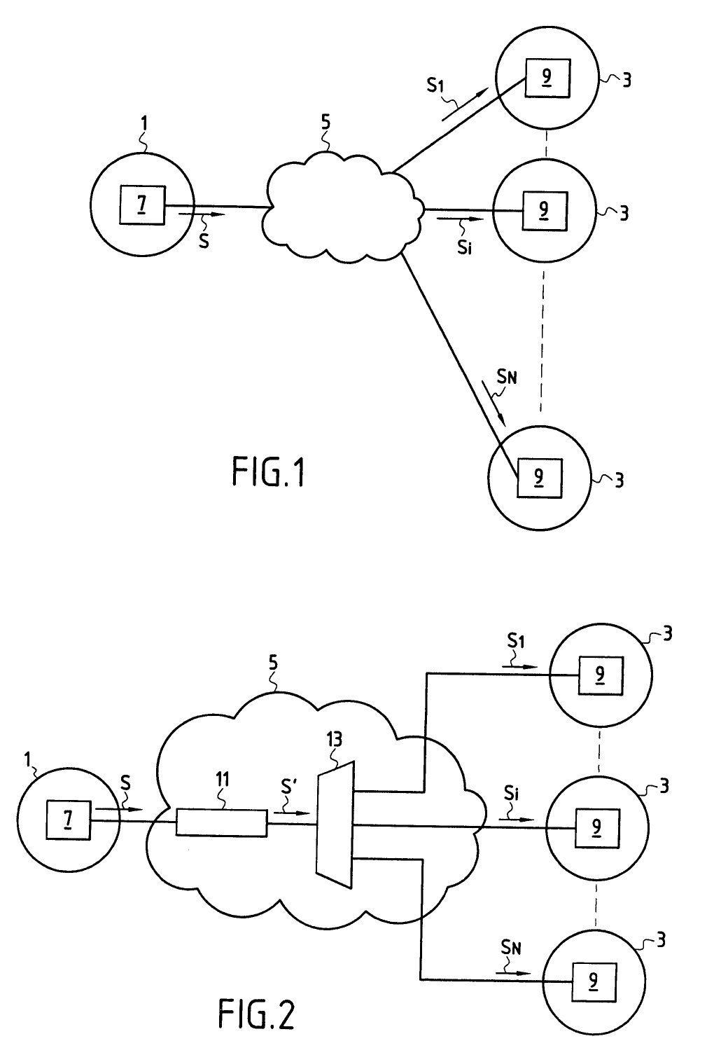

FIG. 1 illustrates a highly-diagrammatic example of a system of the invention for optical transmission between a first unit 1 and a plurality of second units 3. The first and second units are interconnected by means of a passive optical network (PON) 5.

The first unit 1 includes a transmitter 7 for sending data carried by an optical signal S at a single wavelength to the plurality of second units 3. The plurality of second units 3 includes a plurality of receivers 9 intended to receive the data in a plurality of optical signals S₁, . . . , S_{N} at a plurality of different wavelengths. Note that in this example, N designates a number greater than or equal to the number of second units 3, so that each second unit 3 is intended to receive data that is associated with it on at least one specific wavelength.

Thus, with an optimum architecture, a single wavelength is sent by the first unit 1 and at least one specific wavelength is allocated to each second unit 3.

Furthermore, the optical signal S sent by the transmitter 7 of the first unit 1 is an amplitude-division multiplexed optical signal having a plurality of amplitudes and at least one particular amplitude is assigned to each of said second units 3.

Thus amplitude-division multiplexing the optical signal S enables the instantaneous allocation to each second unit 3 of a clearly-defined amplitude of the pulses of this signal S carrying the data. The data intended for each second unit 3 is time-division multiplexed, but each data frame is sent with a different power (amplitude).

FIG. 2 shows that the passive optical network 5 of the optical transmission system includes non-linear means 11 intended to convert amplitude-division multiplexing to wavelength-division multiplexing.

The non-linear means 11 convert the single wavelength of the optical signal sent by the first unit 1 into a plurality of wavelengths as a function of the plurality of amplitudes, by spectrum shifting. The wavelength of each frame increases by an amount that depends on the optical power of the frame. Thus a wavelength-division multiplexed (WDM) optical signal S′ is formed at the output of the non-linear means 11.

The conversion from time-division multiplexing (TDM) to wavelength-division multiplexing (WDM) produces a spatial distribution of the wavelengths such that each second unit receives only the wavelength that is associated with it.

The optical transmission system includes a low-loss optical demultiplexer 13 disposed downstream of the non-linear means 11. This demultiplexer 13 is intended to demultiplex the wavelength-division multiplexed optical signal S′ into the plurality of optical signals S₁, . . . , S_{N} in order to send them to the plurality of second units 3.

Thus the demultiplexer 13 allocates to each second unit 3 a weakly attenuated signal (losses independent of the number of channels) at a specific wavelength. A demultiplexer 13 disposed downstream of the non-linear means 11 enables those non-linear means 11 to shift the wavelength proportionately to the power of the data intended for each second unit 3. Consequently, each second unit 3 receives only the wavelength that is associated with it, which enhances data security and simplifies the reception system.

Since the time-division multiplexed data is also amplitude-division multiplexed (a given amplitude corresponding to a specific second unit 3), the non-linear means 11 placed just ahead of the optical demultiplexer 13 (in relation to the travel direction of the stream or signal S) shift the wavelength of the signal S proportionately to the amplitude of the pulses constituting it. Thus, downstream of the non-linear means 11, just ahead of the optical demultiplexer 13, the amplitude-division multiplexed data is also wavelength-division multiplexed.

Of course, care must be taken that on passing through the non-linear means 11, the spectrum shift generated corresponds to the spectrum allocations of the optical demultiplexer 13.

Moreover, the non-linear spectrum shifting effect produced by the non-linear means 11 can be of the soliton self-frequency shift type, the self-phase modulation type, or any other type leading to the same spectrum shifting effect.

The soliton self-frequency shift phenomenon is a physical phenomenon reported by Mollenauer and Mitschke in “Discovery of the soliton self-frequency shift”, (Optics Letters, Vol. 11, No. 10, pp. 659-661, October 1986).

In an optical fiber, a pulse (for example S) of soliton type (secant hyperbolic profile) conveying more energy than the fundamental soliton is subjected to non-linear compression. If the compression factor is sufficiently high, a pulse of high peak power is generated. The time compression induces strong spectrum widening, which enables Raman diffusion to act on the pulse. Thus the Raman effect subjects the spectrum of the pulse to a frequency shift proportional to the levels of non-linearity of the non-linear means 11. The spectrum shift generated by the soliton self-frequency shift of the non-linear means 11 is proportional to the peak power of the pulse created, or inversely proportional to its time width. The greater the peak power, in other words the higher the compression factor, the greater the frequency shift. Initial pulses, having different peak powers, will therefore give rise to pulses of different wavelengths by non-linear compression and then by soliton self-frequency shift.

Consider by way of example a data stream or signal S at 40 gigabits per second (Gbit/s) sent by the first unit 1 with pulses τ of about 8 picoseconds (ps) and of time width (duty cycle) of about 33% and having a wavelength λ equal to 1550 nm.

Consider also non-linear means 11 consisting of a chalcogenide glass fiber element of non-linear index n₂ equal to 2.10⁻¹⁸ square meters per watt (m²/W) and effective area A_{eff} equal to 50 square micrometers (μm²) Note that the non-linear index n₂ of the chalcogenide glass fiber is much higher than that of a standard glass fiber. Moreover, a level of chromatic dispersion D equal to 10 picoseconds per nanometer per kilometer (ps/nm/km) can be chosen for this glass fiber.

Taking into account the speed c of light in a vacuum, the dispersion length Z_{D} of the soliton is given by the following equation:

$${Z}_{D} = \frac{2 π c \cdot {τ}^{2}}{{1.763}^{2} {λ}^{2} D} \qquad ( 1 )$$

Thus, according to the above data, the dispersion length Z_{D} is equal to 1.6155 kilometers (km). Moreover, the soliton period Z₀ is given by the following equation:

$${Z}_{0} = \frac{π {Z}_{D}}{2} \qquad ( 2 )$$

so that, in this example, the soliton period Z₀ is equal to 2.5377 km. The peak power P₀ of the fundamental soliton then has the value:

$${P}_{0} = \frac{0.776 {λ}^{3} {A}_{eff} D}{{π}^{2} {cn}_{2} {τ}^{2}} \qquad ( 3 )$$

so that, in this example, the peak power P₀ has the value 3.8124 milliwatts (mW). The mean power of the corresponding pulse stream is then equal to −1.5991 decibels relative to one milliwatt (dBm).

Moreover, the dispersion length L_{D} and the non-linear length L_{NL} corresponding to the propagation of a pulse of width 8 ps and of peak power P_{C} in the chalcogenide glass non-linear fiber (non-linear means 11) are given by the following equations:

$${L}_{D} = \frac{2 π c \cdot {τ}^{2}}{{λ}^{2} D} \\ {L}_{NL} = \frac{λ {A}_{eff}}{2 π {n}_{2} {P}_{C}} \qquad ( 4 )$$

Note that the pulses can be considered as very close to N^{th} order solitons if their peak power P_{C} satisfies the equation:

$${N}^{2} = \frac{{L}_{D}}{{L}_{NL}} = \frac{4 {π}^{2} {n}_{2} c {τ}^{2} {P}_{C}}{{λ}^{3} D {A}_{eff}} {P}_{C} \frac{{λ}^{3} D {A}_{eff} {N}^{2}}{4 {π}^{2} {n}_{2} c {τ}^{2}} \qquad ( 5 )$$

For example, for N=2, the corresponding peak power P_{C} then has the value 4.9 mW.

N=2 [symbol] P_{C}4.9 mW (6)

On injecting these pulses with the peak powers calculated above into the non-linear means 11, the compression factor F_{C} of these pulses is given by the equation:

F_{C}=4.1N (7)

The length of fiber Lₒₚₜ necessary to obtain this compression therefore has the value:

$${L}_{opt} = \frac{0.32}{N} + \frac{1.1}{{N}^{2}} \qquad ( 8 )$$

### i.e. for N=2:

N=2 [symbol] F_{c}=8.2 and Lₒₚₜ=1100 m (9)

The compression factor is therefore about 8 (the width of the pulse after compression is equal to 1 ps) and the length of chalcogenide glass fiber necessary to obtain that compression is equal to 1100 meters (m).

This phase of non-linear compression of the pulses is followed by spectrum shifting of the pulses by the soliton self-frequency shift effect. The spectral shift per unit length dΩ₀/dz generated by the soliton self-frequency shift is given by the following equation (J. P. Gordon, “Theory of the soliton self-frequency shift”, Optics Letters, Vol. 11, No. 10, pp. 662-664, October 1986):

$$\frac{d {ω}_{0}}{d z} = \frac{π}{8} {\int }_{0}^{∞} \frac{{Ω}^{3} {α}_{R} ( Ω )}{sin {h}^{2} ( \frac{π Ω}{2} )} d Ω \qquad ( 10 )$$

where ω₀ is the normalized frequency of the soliton, α_{R} is the coefficient of Raman attenuation of the fiber used, and Ω is the spectrum deviation in soliton units. This is linked to the Raman gain g_{R} of the fiber by the following equation:

$${α}_{R} ( Ω ) = \frac{λ}{2 π {n}_{2}} {g}_{R} ( v ) with v = \frac{1.763 Ω}{2 π τ} \qquad ( 11 )$$

in which ν is the frequency shift in terahertz (THz).

It is known that a chalcogenide glass fiber (the non-linear means 11) has a Raman efficacy about 700 times greater than that of a silica glass fiber. The peak value of the Raman gain g_{R} of a silica fiber being 1.10⁻¹³ meters per watt (m/W), that of a chalcogenide glass fiber is therefore of the order of 7.10⁻¹¹ m/W. At the peak, the Raman attenuation coefficient α_{R} can therefore be written as follows:

$${α}_{R}^{Max} = \frac{λ}{2 π {n}_{2}} {7.10}^{- 11} \qquad ( 12 )$$

or, as a numerical value:

α_{R}^{Max}=8.634 (13)

On reverting to real units, equation (4) therefore becomes:

$$\frac{d {v}_{0}}{d z} = \frac{{1.763}^{3}}{π {z}_{c} {τ}^{3}} \frac{d {ω}_{0}}{d z} = \frac{{1.763}^{3} {λ}^{2} D}{16 π c {τ}^{3}} {\int }_{0}^{∞} \frac{{Ω}^{3} {α}_{R} ( Ω )}{sin {h}^{2} ( \frac{π Ω}{2} )} d Ω \qquad ( 14 )$$

because:

$${α}_{R} ( Ω ) = 8.634 \cdot ( \frac{Ω}{Δ {v}_{Max}} ) \qquad ( 15 )$$

It is assumed that the Raman gain peak occurs at a frequency Δν_{Max} equal to 13.2 THz from the pump. Equation (8) can be written as follows:

$$\frac{d {v}_{0}}{d z} = \frac{{1.763}^{4} {λ}^{2} D}{16 π c {τ}^{4}} \frac{8.634}{2 π Δ {v}_{Max}} {\int }_{0}^{∞} \frac{{Ω}^{4}}{sin {h}^{2} ( \frac{π Ω}{2} )} d Ω \qquad ( 16 )$$

because:

$${\int }_{0}^{∞} \frac{{Ω}^{4}}{sin {h}^{2} ( \frac{π Ω}{2} )} d Ω = \frac{16}{15 π} \qquad ( 17 )$$

Equation (10) then becomes:

$$\frac{d {v}_{0}}{d z} = \frac{{1.763}^{4} {λ}^{2} D}{30 {π}^{3} c} \frac{8.634}{Δ {v}_{Max}} \frac{1}{{τ}^{4}} \qquad ( 18 )$$

Expressing the wavelength λ in nm, the chromatic dispersion D in ps/(nm.km), the speed of light c in meters per second (m/s), Δν_{Max} in THz, and τ in ps, equation (12) becomes:

$$\frac{d {v}_{0}}{d z} ( THz / km ) = \frac{{1.763}^{4} {λ}^{2} D}{30 {π}^{3} c} \frac{8.634}{Δ {v}_{Max}} \frac{1}{{τ}^{4}} \cdot {10}^{3} = \frac{0.764}{{τ}^{4}} \qquad ( 19 )$$

For compressed 1 ps pulses τ (emitted by the first unit 1 with a width of 8 ps), a shift of 0.76 THz (approximately 6 nm) per kilometer of fiber is obtained. At the end of 6 km of fiber in total (which includes the 1100 m necessary for the compression), there will be a shift of 3.8 THz (approximately 30 nm).

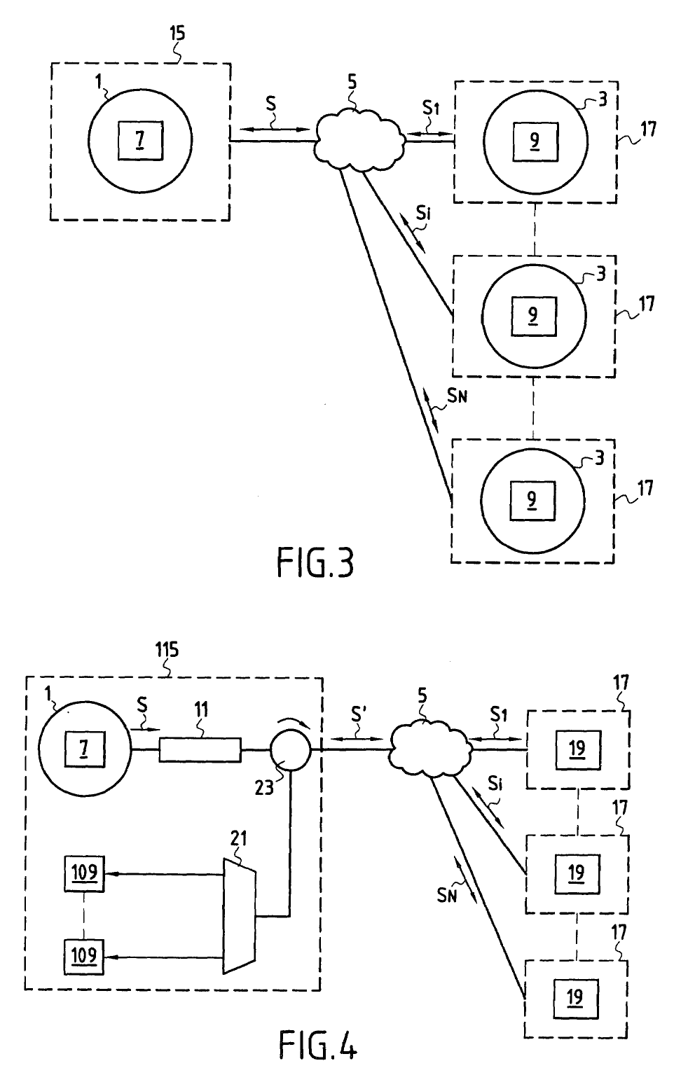

FIG. 3 shows by way of example an optical transmission system comprising a central office terminal 15 comprising the first unit 1 and a plurality of customer (or subscriber) terminals 17 each comprising one second unit 3.

Moreover, it should be noted that one or more second units 3 can be included in a central office terminal 15 and that a first unit 1 can be included in a customer terminal 17.

Considering the configuration where the system from FIG. 3 with the PON type network includes 40 customer (or subscriber) terminals 17 and the bit rate per customer terminal 17 is 1 Gbit/s, then considering 40 (peak) power values of frames distributed from 3.8 to 4.9 mW, it is possible to distribute the 40 downlink wavelengths (going to the 40 customer terminals 17) over a band of 30 nm, i.e. approximately 1 wavelength every 100 GHz.

Note that the photodetection of 1 ps pulses does not give rise to any particular problem given that the bit rate downstream of the optical demultiplexer 13 is only 1 Gbit/s. An ultra-fast detector is therefore not necessary, because the aim here is not to succeed in resolving the pulse but to distinguish a “1” from a “0”.

Moreover, crosstalk between WDM channels is significant only if the soliton self-frequency shift has not accumulated sufficiently (in other words if the non-linear fiber is too short).

However, propagation over a few hundred meters without amplification of the pulses in the standard fiber (dispersion length equal to 14 m if the pulses have a width of 1 ps on entering the fiber) has the effect of widening the pulses (destabilizing soliton propagation) and compressing the spectrum, so that no significant crosstalk or interference is observed at the demultiplexer 13.

The above numerical example demonstrates the efficacy of the soliton self-frequency shift for spectral demultiplexing of a 40 Gbit/s data stream, with orders of magnitude for the various parameters of the demultiplexer 13 that are entirely reasonable.

Thus the invention reconciles the advantages of the two types of PON type network architecture. In other words, the central office terminal 15 sends a single wavelength and a low-loss optical demultiplexer is implemented in the network so that each subscriber is associated with one wavelength that is specific to them.

FIGS. 4 to 6 show various embodiments of the central office terminal from FIG. 3.

In those embodiments, the optical transmission central office terminal 115, 215, 315 includes a transmitter 7 intended to send data carried by an amplitude-division multiplexed optical signal S at a single wavelength and non-linear means 11 intended to convert the amplitude-division multiplexed optical signal S into a wavelength-division multiplexed optical signal S′ by spectrum shifting.

Because a single transmitter 7 is sufficient for sending an optical signal having a single wavelength with non-linear means 11 for spatial distribution of the wavelengths, the architecture of the equipment is very simple.

Furthermore, the optical transmission customer terminal 17 includes a transceiver 19 intended to receive or send data carried by an optical signal Sᵢ at a specific wavelength from or to the optical transmission central office terminal 115, 215, 315. Thus each customer terminal 17 is very secure and very simple because it is not necessary to employ dedicated means for extracting the data intended for it.

FIG. 4 shows a first embodiment in which the central office terminal 115 includes a receive demultiplexer 21, a plurality of receivers 109 connected to the receive demultiplexer 21, and a circulator 23 disposed between the non-linear means 11 and the receive demultiplexer 19. Thus the circulator 21 can route the optical signals S′ sent and received by the central office terminal 115 appropriately.

In the FIG. 4 example the TDM-WDM conversion relates to downlink optical signals (going to the customer terminals 17). For the data going to the central office terminal 115 (from the customer terminals 17), the network can be a standard WDM PON type network using wavelength-division multiplexing-demultiplexing. The circulator 21 placed between the non-linear means 11 and the receive optical demultiplexer 19 routes the downlink and uplink traffic appropriately.

FIG. 5 shows a second embodiment in which the central office terminal 215 includes further non-linear means 211, a receiver 209 connected to these further non-linear means 211, and a circulator 23 disposed between the non-linear means 11 and the further non-linear means 211.

The provision of the further non-linear means 211 on the uplink stream enables the use of only one receiver 209 in the central office terminal 215. The further non-linear means 211 retune the various channels to a single wavelength slightly higher than that of the uplink channel with the highest wavelength. It is naturally necessary in each customer terminal 17 to send frames at a power such that the wavelengths can be retuned satisfactorily in terms of frequency. The advantage of this second embodiment is having only one receiver 209 in the central office terminal 215, provided that fine synchronization is applied on sending the uplink signals so that those signals are interleaved correctly in time.

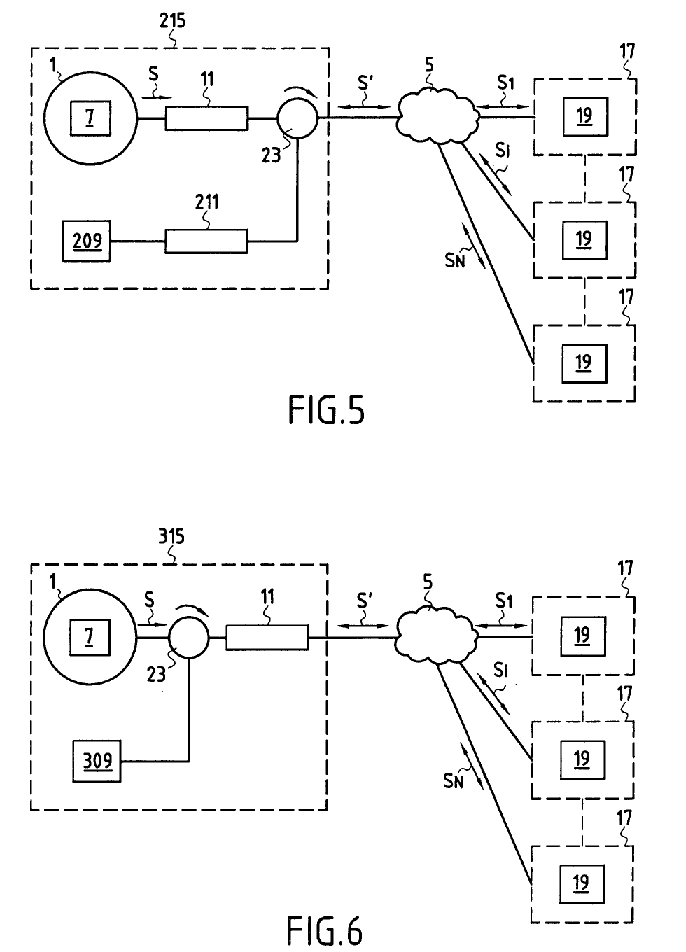

FIG. 6 shows a third embodiment, in which the central office terminal 315 includes a receiver 309 and a circulator 23 connected to the receiver 309. In this embodiment, the circulator 23 is disposed between the transmitter 7 and the non-linear means 11.

Thus, in this third embodiment, the same non-linear means 11 operate on the downlink streams and the uplink streams. In the central office terminal 315 (in respect of the downlink stream) and the customer terminals 17 (in respect of the uplink streams), it is necessary to apply precise power-division multiplexing of the various frames in order for the spectrum shifts generated to correspond correctly to the diagram of the demultiplexer 13 (for the uplink stream) and the single transport wavelength (for the downlink streams). Time synchronization of the uplink frames in the customer terminals 17 is also necessary.

With the embodiments of FIGS. 4 to 6, it is also possible to exploit the fact that the frame powers are different for connecting customers located at different distances. Customers near the central office terminal 115, 215, 315 are associated with wavelengths from frames of lower power (shorter wavelengths). Customers farther away are connected by means of wavelengths from frames of higher power (longer wavelength). All this can be managed in the central office terminal 115, 215, 315 for the downlink stream and in the customer terminals 17 for the uplink streams.

1.-12. (canceled)

13. An optical transmission method of transmitting downlink and uplink data traffic between a central office terminal (115; 215; 315) and a plurality of customer terminals (17) interconnected by means of a passive optical access network (5), comprising the steps of:
the central office terminal sending data carried by an amplitude division multiplexed optical signal (S) including a plurality of amplitudes and having a single wavelength to said plurality of customer terminals (17);
the central office terminal (115; 215; 315) converting the single wavelength of said optical signal (S) sent by said central office terminal (115, 215, 315) into a plurality of wavelengths according to said plurality of amplitudes, by spectrum shifting, thereby forming a wavelength-division multiplexed optical signal (S′), so that said data is received by said plurality of customer terminals (17) in a plurality of optical signals (S₁, . . . , S_{N}) at a plurality of different wavelengths, each of said customer terminals (17) receiving the data that is associated with it on at least one specific wavelength; and
routing said downlink and uplink traffic between said central office terminal (115, 215, 315) and said plurality of customer terminals (17).

14. The method according to claim 13, wherein said conversion by spectrum shifting is effected by a non-linear effect of the soliton self-frequency shift type.

15. An optical transmission central office terminal (115; 215; 315) suitable for providing downlink and uplink data traffic with a plurality of customer terminals (17) interconnected by means of a passive optical access network (5), the central office terminal (115; 215; 315) comprising:
a transmitter (7) for sending data carried by an amplitude-division multiplexed optical signal (S) having a plurality of amplitudes and having a single wavelength to said plurality of customer terminals (17) via a passive optical network (5);
a least one non-linear means (11) for converting the single wavelength of said optical signal (S) into a plurality of wavelengths according to said plurality of amplitudes, by spectrum shifting, thereby forming a wavelength-division multiplexed optical signal (S′), so that said data is received by said plurality of customer terminals (17) in a plurality of optical signals (S₁, . . . , S_{N}) at a plurality of different wavelengths; and
a circulator (23) for routing said downlink and uplink traffic between said central office terminal (115; 215; 315) and said plurality of customer terminals (17).

16. The terminal according to claim 15, wherein said at least one non-linear means (11) is suitable for converting said amplitude-modulated single-wavelength light signal (S) into said wavelength-division multiplexed light signal (S′) by a non-linear soliton self-frequency shift effect.

17. The terminal according to claim 15, wherein said circulator (23) is disposed between said non-linear means (11) and a receive demultiplexer (21) connected to a plurality of receivers (109).

18. The terminal according to claim 15, comprising first and second non-linear means (11, 211), the first non-linear means (11) being situated between said transmitter (7) and said circulator (23) and the second non-linear means (211) being situated between said circulator (23) and a receiver (209).

19. The terminal according to claim 15, wherein said circulator (23) is disposed between the transmitter (7) and said non-linear means (11) and said circulator (23) is connected to a receiver (309).
